(19) United States
(12) Patent Application Publication
(10) Pub. No.: US 2009/0006195 A1
(43) Pub. Date: Jan. 1, 2009

(54) System for targeting communications based on media interaction habits

(75) Inventors: Alan Rosen, Shelton, CT (US); Jeffrey D. Pierce, Sandy Hook, CT (US); Thomas J. Foth, Trumbull, CT (US); Gary G. Hansen, Newtown, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/823,514

(22) Filed: Jun. 28, 2007

(51) Int. Cl. G06Q 30/00

(52) U.S. Cl. 705/14

(57) ABSTRACT

A method of sending a targeted communication on behalf of an interested party to individuals that access media content through a media service provider includes receiving information regarding particular media content accessed by each of the individuals from the associated media service providers, storing that information in a secure manner, establishing one or more criteria for identifying desired recipients of the communication, identifying selected individuals to receive the communication based on the one or more criteria and the particular media content information, and causing the communication to be sent to the selected individuals by one of one or more communication methods.

### FIELD OF THE INVENTION

The present invention relates to systems for targeting communications, such as advertisements, to individuals, and in particular to a system for targeting communications, such as advertisements, to individuals based on their media interaction/usage habits which maintains such information in a confidential manner and does not disclose such information to the sending parties.

### BACKGROUND OF THE INVENTION

For many reasons, an entity such a corporation or some other organization or an individual would like to able to track the media interaction habits, such as the Internet browsing habits or television watching habits, of individuals such as consumers. For example, a marketer of a product or service would often like to be able to monitor and track the web sites and web pages that are viewed by individuals at their homes and/or offices so that such information can be used to provide targeted communications (e.g., product or service advertisements by mail or email) to selected appropriate ones of those individuals. However, it is currently difficult for interested entities to obtain such information. For instance, in the case of Internet browsing habits, it is not possible for an interested entity to obtain such information without explicitly asking website visitors to fill out an online form which identifies the individual. For privacy reasons, the majority of web site visitors prefer not to complete such online forms, and therefore the data collected for a particular web site is most often incomplete. In addition, that information, if collected, would only then be available to the interested entity for web sites operated by or on the behalf of the interested party (and not for unrelated third party web sites). Thus, there is a need for a system for enabling interested entities to send targeted communications to individuals based on their media interaction habits which at the same time preserves the privacy of that information so as to make individuals more likely to participate in such a system.

### SUMMARY OF THE INVENTION

The present invention provides a method of sending a targeted communication on behalf of an interested party, such as a company or individual that markets a product or service, to one or more of a plurality of individuals that access media content, such as, without limitation, a number of web sites/web pages or television programs, through a media service provider such as an Internet service provider or a television service provider like a cable company or a satellite television company. The method includes receiving information regarding particular media content accessed by each of the individuals from the associated media service providers, storing that information in a secure manner wherein the information is not available to or accessible by the interested party, establishing one or more criteria for identifying desired recipients of the targeted communication, identifying selected ones of the individuals to receive the targeted communication based on the one or more criteria and the information regarding the particular media content of each of the individuals, and causing the targeted communication to be sent to the selected ones of the individuals by one of one or more communication methods, such as physical mail or electronic mail.

In one embodiment, the establishing step includes receiving a request from the interested party that includes the one or more criteria. Alternatively, the establishing step may include receiving information from the interested party regarding one or more types of individuals that the interested party would like to have receive the targeted communication, and determining the one or more criteria based on that information. As still a further alternative, the establishing step includes analyzing a plurality of current customers of the interested party and determining the one or more criteria based on that analysis.

The method may include working in cooperation with the interested party to create the targeted communication. Alternatively, the method may include receiving the targeted communication from the interested party.

The method may also further include receiving demographic information for each of the individuals. In this embodiment, the storing step includes storing the information regarding the media particular media content and the demographic information for each of the individuals, and the identifying step includes identifying selected ones of the individuals to receive the targeted communication based on the one or more criteria, the information regarding the particular media content of each of the individuals and the demographic information of each of the individuals.

In an alternative embodiment, the invention provides a method of sending a targeted communication on behalf of an interested party to one or more of a plurality of individuals, each of said individuals accessing one or more web pages through a respective associated fire wall and a respective Internet service provider. The method in this embodiment includes receiving information regarding particular web pages accessed by each of said individuals from the respective associated fire wall and storing the information regarding the media particular web pages in a secure manner wherein the information is not available to or accessible by the interested party. The method further includes establishing one or more criteria for identifying desired recipients of the targeted communication, identifying selected ones of the individuals to receive the targeted communication based on the one or more criteria and the information regarding the particular web pages of each of the individuals, and causing the targeted communication to be sent to the selected ones of the individuals by one of one or more communication methods.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic diagram of a system for enabling interested parties to specifically target individuals based upon their media interaction habits according to an embodiment of the present invention;

FIG. 2 is a flowchart illustrating an embodiment of a method according to the present invention which employs the system shown in FIG. 1 to target specific individuals based upon their media interaction habits;

### DESCRIPTION OF THE PREFERRED EMBODIMENTS

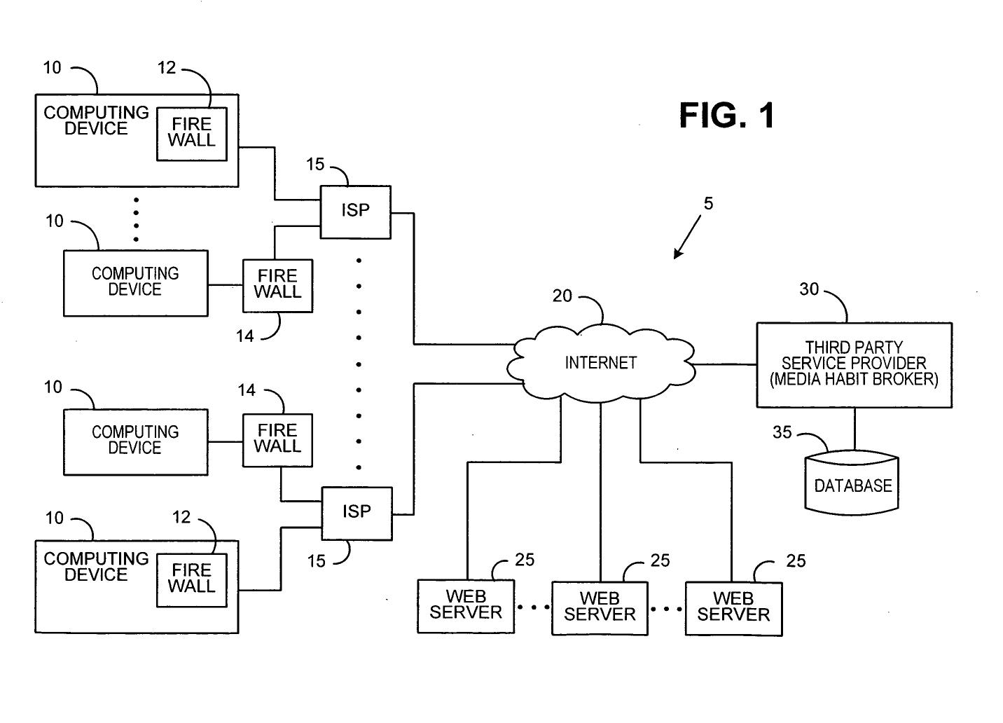

FIG. 1 is a schematic illustration of a system 5 for enabling interested parties, such as an individual or a company that is interested in marketing a product or service, to specifically target individuals and have communications sent to such individuals based upon their media interaction habits. Such media interaction habits may include, for example, and without limitation, the Internet browsing habits or the television viewing habits of the individuals. The system 5, as described in further detail below, provides the interested parties with a means for causing a targeted communication to be sent to the targeted individuals using a medium such as physical mail delivered through a postal service like the U.S. Postal Service or electronic mail. For illustration purposes, the embodiment of the system 5 shown in FIG. 1 enables individuals to be targeted based upon their Internet browsing habits. It should be understood, however, that this is meant to be illustrative only and that other media interaction habits may also be the subject of the present invention.

As seen in FIG. 1, the system 5 includes a plurality of computing devices 10, each of which is under the control of and operated by an individual, such as a consumer. Each computing device 10 may be, for example and without limitation, a personal computer, a PDA, or any other suitable electronic device. Each computing device 10 is in electronic communication (wired or wireless) with an Internet service provider 15 which enables the computing device 10 to be connected to the Internet 20. Preferably, as seen in FIG. 1, each computing device 10 is in electronic communication (wired or wireless) with an Internet service provider 15 through either an internal fire wall 12 (such as one of the internal fire wall products sold by McAfee, Inc.) or an external fire wall 14 (such as the model WRT 54G sold by the Linksys division of Cisco Systems, Inc.), which fire walls will, as described elsewhere herein be employed in an alternative embodiment of the present invention. As is known in the art, each individual is thus able to access the Internet 20 using his or her computing device 10 through the associated Internet service provider 15, and visit (i.e., be connected to and receive information from) selected web sites and receive selected web pages through the Internet 20 from web servers 25 that maintain and provide such web sites and web pages. When the individuals browse the Internet in this manner, each respective Internet service provider 15 maintains a record of the particular website and/or web pages that are accessed by each particular computing device 10.

As seen in FIG. 1, the system 5 further includes a third party service provider 30 that is in electronic communication with the Internet 20 through, for example, one or more server computers. As described elsewhere herein, the third party service provider 30 acts as an anonymous broker of media habits by collecting information regarding the media interaction habits of the individuals and helping interested parties to target those individuals by facilitating the transmission of targeted communications to the individuals at the request of the interested parties (e.g., interested marketers). To provide this function, the third party service provider 30 maintains a database of information 35 which is described in greater detail below.

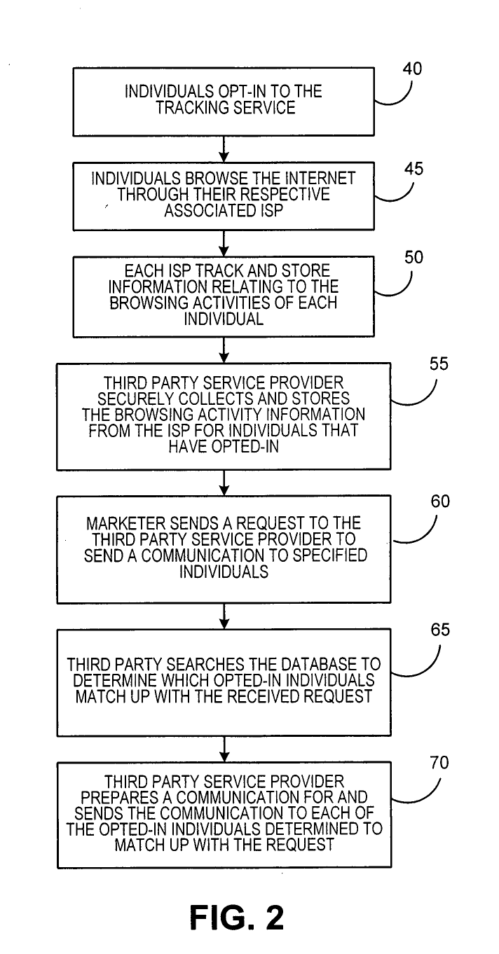

FIG. 2 is a flowchart of a method according to particular embodiment of the present invention which employs the system 5 to target specific individuals based upon their media interaction habits. Again, the method shown in FIG. 2 is based upon the Internet browsing habits of the individuals to be targeted, but it should be understood that this is meant to be illustrative only and that other media interaction habits may also be used as the basis for contacting the individuals (e.g., the television viewing habits of the individuals). In addition, the method shown in FIG. 2 is an embodiment where, in the system 5, the third party service provider 30 provides individuals the opportunity to opt-in to the tracking service if they desire to receive targeted communications from the interested parties. It is this opt-in process that will, as described further below, provide the permission to each individual's respective Internet service provider 15 to provide information regarding their Internet browsing habits to the third party service provider 30. Without such authorization, the Internet service providers 15 maintain that Internet browsing activity information as confidential. As will be appreciated, any individuals that do not opt-in will, in this embodiment, not receive any targeted communications since their Internet browsing activity information will not be provided to the third party service provider 30.

Referring to FIG. 2, the method begins at step 40, wherein a plurality of individuals, each one utilizing one of the computing devices 10 shown in FIG. 1, opt-in to the tracking service maintained by the third party service provider 30. Next, at step 45, the individuals that have opted-in selectively browse the Internet 20 through their respective associated Internet service providers 15 and visit selected web sites and receive selected web pages maintained by particular ones of the web servers 25. At step 50, each Internet service provider 15 tracks and stores information relating to the browsing activities of each of the individuals. In particular, each Internet service provider 15 will maintain a database which tracks the identity of each individual (which will typically be established through the process of opening and maintaining an account for service with the Internet service provider 15) and the identification of the particular web sites and web pages accessed by the computing device 10. Typically, the time of each such accessing activity will also be tracked and stored.

At step 55, the third party service provider 30 periodically collects the browsing activity information for each of the individuals that have opted-in in step 40 from each of the Internet service provider 15. Preferably, the third party service provider 30 will at the same time collect certain demographic information relating to each individual that has been provided to the associated Internet service provider 15 (typically when the account is established). In addition, the third party service provider 30 securely stores the browsing activity information that it has collected in the database 35. Typically, the third party service provider 30 perform these steps by securely contacting each Internet service provider 15 through the Internet 20 and securely receiving the above described information from the Internet service provider 15 through the Internet 20. Upon receiving that information, the third party service provider will store such information in the database 35.

The database 35 will thus comprise a store of information that includes for each individual the identification of the individual, preferably certain demographic information relating to the individual, and the identification of each of (and preferably the accessing time of) the web sites and web pages that were accessed by the individual during a selected time period (e.g., since last time the information was collected). It is this store of information that is maintained in the database 35 that the third party service provider 30 uses as the basis of its targeted communication service. In particular, as described below, the third party service provider 30 enables interested parties, such as an interested marketer, to request that targeted communications be provided to certain individuals that are identified based upon certain predetermined criteria (which in the current embodiment is supplied by the interested party) and on the information stored in the database 35. Thus, at step 60, an interested party such as an interested marketer that desires to use the service sends a service request to the third party service provider 30. That service request will inform the third party service provider 30 that the interested party wishes to have a targeted communication sent to certain types of individuals. In the particular embodiment shown in FIG. 2, the interested party will, in that request, provide the criteria which are to be used to identify the types of individuals that are to receive the communication. For example, the criteria may specify all individuals that visited the website(s) that is maintained by that particular interested party through a web server 25 operated by or on behalf of the interested party. As another example, the criteria may specify those individuals that visited a specific list of websites that are maintained by selected ones of the web servers 25. As still another example, the criteria may specify individuals that visited one or more websites falling within particular categories of websites, such as, for example, websites related to consumer electronics, websites related to sports, websites related to automobiles, or any other subject matter that may be used to target particular products and/or services to individual consumers.

Next, at step 65, after receiving the request from the interested party, the third party service provider 30 searches the database 35 to determine, based on the stored browsing activity information, which of the opted-in individuals match up with the criteria that was provided in the received request. Once particular ones of the opted-in individuals have been identified, the third party service provider prepares a targeted communication for and sends the targeted communication to each of the opted-in individuals that were determined to match up with the criteria of the request. That targeted communication may, for example, be in the form of a direct mailing (e.g. a brochure or other marketing materials) to be delivered by the U.S. Postal Service or in the form of a marketing email to be provided through the Internet 20 by electronic mail through each computing device 10. In the case of the latter, each individual's email address will preferably be obtained by the third party service provider 30 during the opt-in procedure described at step 40.

In one particular embodiment, the specifics of the targeted communication that is to be sent in step 70 are established by the interested party and are provided to the third party service provider 30. In such a case, the third party service provider 30 does not participate in the establishment of the specifics of the communication. In an alternate embodiment, the third party service provider 30 may provide additional services in which the third party service provider 30 works with the interested party to produce the appropriate communication, such as a brochure or some other type of advertisement media. In still other embodiments, the third party service provider 30 participates more actively in the process of establishing the criteria upon which opted-in individuals are to be identified. In particular, in one embodiment, the third party service provider 30 may query the interested party for information relating to the type of individual that the interested party is attempting to reach with the communication. Based upon that information, the third party service provider 30 then determines an appropriate methodology for identifying the appropriate opted-in individuals based upon the information stored in the database 35. In yet another embodiment where the interested party is a marketer that markets particular products or services to customers, the third party service provider 30 will conduct an analysis of the interested party's current customers to determine appropriate criteria for selecting the appropriate opted-in individuals from the database 35. In this case, that criteria will be the criteria that is used to determine which opted-in individuals are to receive the targeted communication (step 65).

In an alternative embodiment, rather than having an opt-in procedure as described above, the third party service provider 30 may automatically enroll individuals in the tracking service and provide individuals the opportunity to opt-out of the tracking service if they do not desire to receive targeted communications from the interested parties. In this embodiment, step 40 in FIG. 2 would be replaced with a step wherein a plurality of individuals decide not to opt-out of the tracking service maintained by the third party service provider 30, and step 55 would be replaced by a step wherein the third party service provider 30 periodically collects the browsing activity information for each of the individuals that have not opted-out from each of the Internet service provider 15.

In another alternative embodiment, rather than having the ISPs 15 track and store information relating to the browsing activities of each individual, that task may be performed by the internal fire wall 12 or external fire wall 14, as the case may be, that is associated with each individual's computing device 10. In this embodiment, step 50 in FIG. 2 would be replaced with a step wherein each internal fire wall 12 or external fire wall 14, as the case may be, tracks and stores information relating to the browsing activities of each of the individuals, and step 55 would be replaced by a step wherein the third party service provider 30 periodically collects the browsing activity information for each of the individuals that have either opted-in or not opted-out (depending on the particular embodiment that is implemented) from each of the fire walls 12 and 14.

As noted elsewhere herein, the present invention is not limited to targeting communications based upon Internet browsing habits of individuals, but instead may be based upon other media interaction habits. For example, the third party service provider 30 may receive and store information regarding the television viewing habits of individuals, including the particular channels and/or programs that are watched by the individuals. This information may be obtained by the third party service provider 30 from the cable operator and/or satellite television operator that provides television service to the individuals that have opted-in to the tracking system. Again, in such a case, the opt-in procedure will provide the authorization for the particular cable operator and/or satellite television operator to release the television watching information to the third party service provider 30.

Thus, the present invention provides a system wherein interested parties are able to target communications to appropriate individuals without the individuals private information being disclosed to those interested parties. Instead, that information is maintained in confidence by the third party service provider 30, and thus is unlikely to be improperly disclosed and/or abused. As a result, individuals are more likely to be willing to participate in such a system and more willing to receive the targeted communications.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of sending a targeted communication on behalf of an interested party to one or more of a plurality of individuals, each of said individuals accessing media content through a respective one of one or more media service providers, comprising:
receiving information regarding particular media content accessed by each of said individuals from the one or more media service providers;
storing said information regarding said media particular media content in a secure manner wherein said information regarding said particular media content is not available to or accessible by said interested party;
establishing one or more criteria for identifying desired recipients of said targeted communication;
identifying selected ones of said individuals to receive said targeted communication based on said one or more criteria and said information regarding said particular media content of each of said individuals; and
causing said targeted communication to be sent to said selected ones of said individuals by one of one or more communication methods.

2. The method according to claim 1, wherein said establishing step includes receiving a request from said interested party, said request including said one or more criteria.

3. The method according to claim 1, wherein said establishing step includes receiving information from said interested party regarding one or more types of individuals that said interested party would like to have receive said targeted communication, and determining said one or more criteria based on said information regarding one or more types of individuals.

4. The method according to claim 1, wherein said establishing step includes analyzing a plurality of current customers of said interested party and determining said one or more criteria based on said analyzing step.

5. The method according to claim 1, further comprising working in cooperation with said interested party to create said targeted communication.

6. The method according to claim 1, further comprising receiving said targeted communication from said interested party.

7. The method according to claim 1, wherein each of said media service providers is an Internet service provider and wherein for each of said individuals said particular media content comprises one or more web pages accessed by said individual.

8. The method according to claim 7, wherein said one or more criteria specifies one or more particular web sites and wherein said identifying step includes determining for each of said individuals whether said individual visited at least one of said one or more particular web sites.

9. The method according to claim 7, wherein said one or more criteria specifies one or more categories of web sites and wherein said identifying step includes determining for each of said individuals whether said individual visited at least one web site falling within at least one of said one or more categories.

10. The method according to claim 1, wherein each of said media service providers is television content provider and wherein for each of said individuals said particular media content comprises one or more television programs viewed by said individual.

11. The method according to claim 1, wherein said causing step comprises causing said targeted communication to be sent to said selected ones of said individuals by the same communication method.

12. The method according to claim 1, wherein said causing step comprises causing said targeted communication to be sent to a first group of said selected ones of said individuals by a first communication method and to a second group of said selected ones of said individuals by a second communication method.

13. The method according to claim 12, first communication method is physical mail and said second communication method is electronic mail.

14. The method according to claim 1, wherein for each of said selected ones of said individuals said one of one or more communication methods is specified by said individual.

15. The method according to claim 1, wherein said storing step includes storing said information regarding said media particular media content for each of said individuals in association with a name of said individual.

16. The method according to claim 1, further comprising receiving demographic information for each of said individuals, wherein said storing step includes storing said information regarding said media particular media content and said demographic information for each of said individuals, and wherein said identifying step includes identifying selected ones of said individuals to receive said targeted communication based on said one or more criteria, said information regarding said particular media content of each of said individuals and said demographic information of each of said individuals.

17. The method according to claim 1, further comprising receiving an authorization from each of said individuals to receive said information regarding particular media content accessed by each of said individuals and providing each said authorization to the media service provider associated with said individual.

18. A method of sending a targeted communication on behalf of an interested party to one or more of a plurality of individuals, each of said individuals accessing one or more web pages through a respective associated fire wall and a respective Internet service provider, comprising:
receiving information regarding particular web pages accessed by each of said individuals from the respective associated fire wall;
storing said information regarding said media particular web pages in a secure manner wherein said information regarding said particular web pages is not available to or accessible by said interested party;
establishing one or more criteria for identifying desired recipients of said targeted communication;
identifying selected ones of said individuals to receive said targeted communication based on said one or more criteria and said information regarding said particular web pages of each of said individuals; and
causing said targeted communication to be sent to said selected ones of said individuals by one of one or more communication methods.

19. The method according to claim 18, wherein said one or more criteria specifies one or more particular web sites and wherein said identifying step includes determining for each of said individuals whether said individual visited at least one of said one or more particular web sites.

20. The method according to claim 18, wherein said one or more criteria specifies one or more categories of web sites and wherein said identifying step includes determining for each of said individuals whether said individual visited at least one web site falling within at least one of said one or more categories.
